(19) United States
(12) Patent Application Publication
(10) Pub. No.: US 2022/0326739 A1
(43) Pub. Date: Oct. 13, 2022

(54) Tablet Keyboard System

(71) Applicant: Brydge Global Pte Ltd., Park City, UT (US)

(72) Inventors: Nicholas James Smith, Park City, UT (US); Toby Mander-Jones, Park City, US (US); Brian Jeffrey Kenton, Salt Lake City, UT (US)

(21) Appl. No.: 17/715,564

(22) Filed: Apr. 7, 2022

Related U.S. Application Data
(60) Provisional application No. 63/173,252, filed on Apr. 9, 2021.

(51) Int. Cl. G06F 1/16

(52) U.S. Cl. CPC G06F 1/1664; G06F 1/1669; G06F 1/1654; G06F 1/1626; G06F 1/1616; G06F 1/1681

(57) ABSTRACT

In some aspects, the techniques described herein relate to a tablet keyboard system for a creating a laptop experience with a clamshell design, including: a backplate bottom edge being flush with the bottom frame boundary when the tablet keyboard system is in a closed position, and below the bottom frame boundary when the tablet keyboard system is in an open position allowing the tablet keyboard system to pivot the frame front edge in an upwards position creating an angle between the bottom frame boundary and a resting surface of the bottom frame boundary for optimizing an ergonomic typing position for a user. Furthermore, an inverse object system including: an inverse object tab for contact with a thumb of the user; and an inverse object recession recessed for contact with an index finger of the user are used with the tablet keyboard system.

### CROSS REFERENCE(S)

This application claims the benefit and priority of U.S. Provisional Application Ser. No. 63/173,252, filed on Apr. 9, 2021, which is hereby incorporated by reference herein in its entirety.

### FIELD OF THE TECHNOLOGY

Embodiments of the disclosure relate to a tablet keyboard system. In particular, the present disclosure relates to a tablet keyboard system that optimizes an ergonomic typing angle for a user of the tablet keyboard system.

### SUMMARY

In some aspects, the techniques described herein relate to a tablet keyboard system. In some aspects, the techniques described herein relate to a tablet keyboard system for a creating a laptop experience with a clamshell design, the tablet keyboard system including: a frame including: a frame front edge; a top frame boundary; and a bottom frame boundary; an electronic keyboard housed by the frame; a tablet computer commutatively coupled with the electronic keyboard, the tablet computer including: a front panel including: a touchscreen display; and a tablet computer front edge; and a back panel; a multitouch trackpad housed by the frame and commutatively coupled with the electronic keyboard and the tablet computer; a backplate supporting the tablet computer and pivotally connected to the frame, the backplate including: backplate magnets for mating with the tablet computer by contact with the tablet computer, the backplate magnets exerting a backplate magnetic retention force on the tablet computer, the backplate magnetic retention force preventing release of the tablet computer from the backplate; a front receiving member for supporting the tablet computer by contact with the tablet computer front edge, the front receiving member exerting a front receiving member retention force on the tablet computer front edge, the front receiving member retention force on the tablet computer front edge preventing release of the tablet computer from the backplate; and a backplate bottom edge, the backplate bottom edge being flush with the bottom frame boundary when the tablet keyboard system is in a closed position, and the backplate bottom edge being below the bottom frame boundary when the tablet keyboard system is in an open position allowing the tablet keyboard system to pivot the frame front edge in an upwards position creating an angle between the bottom frame boundary and a resting surface of the bottom frame boundary, the angle optimizing an ergonomic typing position for a user; and an inverse object system including: an inverse object tab protruding beyond an external boundary of the tablet computer for contact with a thumb of the user; and an inverse object recession recessed with an internal boundary of the tablet computer for contact with an index finger of the user.

In some aspects, the techniques described herein relate to a tablet keyboard system, wherein the angle between the bottom frame boundary and the resting surface of the bottom frame boundary is greater than zero degrees and less than three degrees, the angle optimizing the ergonomic typing position for the user of the electronic keyboard of the tablet keyboard system.

In some aspects, the techniques described herein relate to a tablet keyboard system, wherein the angle between the bottom frame boundary and the resting surface of the bottom frame boundary is one degree, the angle optimizing the ergonomic typing position for the user of the electronic keyboard of the tablet keyboard system.

In some aspects, the techniques described herein relate to a tablet keyboard system, wherein the angle between the bottom frame boundary and the resting surface of the bottom frame boundary is two degrees, the angle optimizing the ergonomic typing position for the user of the electronic keyboard of the tablet keyboard system.

In some aspects, the techniques described herein relate to a tablet keyboard system, wherein the angle between the bottom frame boundary and the resting surface of the bottom frame boundary is three degrees, the angle optimizing the ergonomic typing position for the user of the electronic keyboard of the tablet keyboard system.

In some aspects, the techniques described herein relate to a tablet keyboard system, wherein simultaneous contact with the inverse object tab by the thumb of the user and contact with the inverse object recession by the index finger of the user causes an inverse object system release force on the tablet computer, the inverse object system release force causing release of the tablet computer from the backplate when the inverse object system release force is greater than a combination of the front receiving member retention force and the backplate magnetic retention force.

In some aspects, the techniques described herein relate to a tablet keyboard system, wherein simultaneous contact with the inverse object tab by the thumb of the user and contact with the inverse object recession by the index finger of the user causes an inverse object system release force on the tablet computer, the inverse object system release force causing release of the tablet computer from the backplate when the inverse object system release force is greater than a combination of the front receiving member retention force and the backplate magnetic retention force.

In some aspects, the techniques described herein relate to a tablet keyboard system, wherein a distance between a center of the inverse object tab protruding beyond the external boundary of the tablet computer for contact with a thumb of the user and a center of the inverse object recession recessed with the internal boundary of the tablet computer for contact with an index finger of the user is an optimal release distance, the optimal release distance being a distance measured of a human hand from a tip of a thumb to a tip of the index finger of the human hand fully stretched, the distance measured being between two and four inches.

In some aspects, the techniques described herein relate to a tablet keyboard system, wherein the backplate magnets for mating with the tablet computer by contact with the tablet computer include: a backplate upper magnet array, the backplate upper magnet array exerting an upper backplate magnetic retention force on the tablet computer, the upper backplate magnetic retention force preventing release of the tablet computer from the backplate; and a backplate lower magnet array, the backplate lower magnet array exerting a lower backplate magnetic retention force on the tablet computer, the lower backplate magnetic retention force preventing release of the tablet computer from the backplate.

In some aspects, the techniques described herein relate to a tablet keyboard system for a creating a laptop experience with a clamshell design, the tablet keyboard system being in an open position including: a frame including: a frame front edge; a top frame boundary; and a bottom frame boundary; an electronic keyboard housed by the frame; a tablet computer commutatively coupled with the electronic keyboard, the tablet computer including: a front panel including: a touchscreen display; and a tablet computer front edge; and a back panel; a multitouch trackpad housed by the frame and commutatively coupled with the electronic keyboard and the tablet computer; a backplate supporting the tablet computer and pivotally connected to the frame, the backplate including: backplate magnets for mating with the tablet computer by contact with the tablet computer, the backplate magnets exerting a backplate magnetic retention force on the tablet computer, the backplate magnetic retention force preventing release of the tablet computer from the backplate; a front receiving member for supporting the tablet computer by contact with the tablet computer front edge, the front receiving member exerting a front receiving member retention force on the tablet computer front edge, the front receiving member retention force on the tablet computer front edge preventing release of the tablet computer from the backplate; and a backplate bottom edge being below the bottom frame boundary with the tablet keyboard system in the open position allowing the tablet keyboard system to pivot the frame front edge in an upwards position creating an angle between the bottom frame boundary and a resting surface of the bottom frame boundary, the angle optimizing an ergonomic typing position for a user; and an inverse object system including: an inverse object tab protruding beyond an external boundary of the tablet computer for contact with a thumb of the user; and an inverse object recession recessed with an internal boundary of the tablet computer for contact with an index finger of the user.

In some aspects, the techniques described herein relate to a tablet keyboard system, wherein a bottom edge of the tablet computer is below the top frame boundary creating the angle between the bottom frame boundary and the resting surface of the bottom frame boundary, the angle further optimizing the ergonomic typing position for the user.

In some aspects, the techniques described herein relate to a tablet keyboard system, wherein the backplate supporting the tablet computer is pivotally connected to the frame using a hinge, the hinge being internal to the frame.

In some aspects, the techniques described herein relate to a tablet keyboard system, wherein the backplate supporting the tablet computer is made of flexible material.

In some aspects, the techniques described herein relate to a tablet keyboard system, wherein, the flexible material is plastic.

In some aspects, the techniques described herein relate to a tablet keyboard system for a creating a laptop experience with a clamshell design, the tablet keyboard system being in a closed position including: a frame including: a frame front edge; a top frame boundary; and a bottom frame boundary; an electronic keyboard housed by the frame; a tablet computer commutatively coupled with the electronic keyboard, the tablet computer including: a front panel including: a touchscreen display; and a tablet computer front edge; and a back panel; a multitouch trackpad housed by the frame and commutatively coupled with the electronic keyboard and the tablet computer; a backplate supporting the tablet computer and pivotally connected to the frame, the backplate including: backplate magnets for mating with the tablet computer by contact with the tablet computer, the backplate magnets exerting a backplate magnetic retention force on the tablet computer, the backplate magnetic retention force preventing release of the tablet computer from the backplate; a front receiving member for supporting the tablet computer by contact with the tablet computer front edge, the front receiving member exerting a front receiving member retention force on the tablet computer front edge, the front receiving member retention force on the tablet computer front edge preventing release of the tablet computer from the backplate; and a backplate bottom edge, the backplate bottom edge being flush with the bottom frame boundary with the tablet keyboard system in the closed position, and an inverse object system including: an inverse object tab protruding beyond an external boundary of the tablet computer for contact with a thumb of a user; and an inverse object recession recessed with an internal boundary of the tablet computer for contact with an index finger of the user.

In some aspects, the techniques described herein relate to a tablet keyboard system for a creating a laptop experience with a clamshell design, the tablet keyboard system including: a frame including: a frame front edge; a top frame boundary; and a bottom frame boundary; an electronic keyboard housed by the frame; a tablet computer commutatively coupled with the electronic keyboard, the tablet computer including: a front panel including: a touchscreen display; and a tablet computer front edge; and a back panel; a multitouch trackpad housed by the frame and commutatively coupled with the electronic keyboard and the tablet computer; a protective case integrated with a backplate, the protective case including: protective case magnets; a protective case middle housing member; the backplate supporting the tablet computer and pivotally connected to the frame, the backplate including: backplate magnets for mating with the protective case magnets, the backplate magnets exerting a backplate magnetic retention force on the protective case, the backplate magnetic retention force preventing release of the protective case from the backplate; a middle protruding member for supporting the tablet computer by contact with the protective case middle housing member, the middle protruding member exerting a middle protruding member retention force on the protective case middle housing member, the middle protruding member retention force preventing release of the protective case from the backplate; a backplate bottom edge, the backplate bottom edge being flush with the bottom frame boundary when the tablet keyboard system is in a closed position, and the backplate bottom edge being below the bottom frame boundary when the tablet keyboard system is in an open position allowing the tablet keyboard system to pivot the frame front edge in an upwards position creating an angle between the bottom frame boundary and a resting surface of the bottom frame boundary, the angle optimizing an ergonomic typing position for a user; and an inverse object system including: an inverse object tab protruding beyond an external boundary of the tablet computer for contact with a thumb of the user; and an inverse object recession recessed with an internal boundary of the tablet computer for contact with an index finger of the user; and a protective case.

In some aspects, the techniques described herein relate to a tablet keyboard system, wherein the protective case magnets include: a protective case upper magnet array, the protective case upper magnet array exerting an upper protective case magnetic retention force on the protective case, the upper protective case magnetic retention force preventing release of the protective case from the backplate; and a protective case lower magnet array, the protective case lower magnet array exerting a lower protective case magnetic retention force on the protective case, the lower protective case magnetic retention force preventing release of the protective case from the backplate.

In some aspects, the techniques described herein relate to a tablet keyboard system, wherein the middle protruding member is embodied in the protective case middle housing member

In some aspects, the techniques described herein relate to a tablet keyboard system, wherein the tablet bottom edge of the tablet computer is below the bottom frame boundary.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

FIG. 1A illustrates tablet keyboard system including a backplate, according to various embodiments of the present technology.

FIG. 1B illustrates tablet keyboard system including a backplate and a protective case, according to various embodiments of the present technology.

FIG. 2A illustrates a keyboard system in an open position optimizing an ergonomic typing angle for a user of the tablet keyboard system, according to various embodiments of the present technology.

FIG. 2B illustrates a keyboard system in a closed position, according to various embodiments of the present technology.

FIG. 3 illustrates a magnified view of a keyboard system in an open position including a top frame boundary and a bottom frame boundary, according to various embodiments of the present technology.

FIG. 4A illustrates a perspective view of tablet keyboard system including a backplate comprising a front receiving member for supporting the tablet computer by contact with the tablet computer front edge, according to various embodiments of the present technology.

FIG. 4B illustrates a magnified view of a tablet keyboard system including a backplate comprising a front receiving member for supporting the tablet computer by contact with the tablet computer front edge, according to various embodiments of the present technology.

FIG. 4C illustrates another magnified view of a tablet keyboard system including a backplate comprising a front receiving member for supporting the tablet computer by contact with the tablet computer front edge, according to various embodiments of the present technology.

FIG. 5 illustrates another magnified view of a tablet keyboard system including a backplate comprising a front receiving member for supporting the tablet computer by contact with the tablet computer front edge and with the backplate supporting the tablet computer and pivotally connected to the frame using a hinge, according to various embodiments of the present technology.

FIG. 6A illustrates another view of a tablet keyboard system including a backplate comprising a front receiving member for supporting the tablet computer by contact with the tablet computer front edge and the backplate pivotally connected to the frame using a hinge with illustration of forces acting on the tablet keyboard system, according to various embodiments of the present technology.

FIG. 6B illustrates a magnified view of a tablet keyboard system including a backplate comprising a front receiving member for supporting the tablet computer by contact with the tablet computer front edge and the backplate pivotally connected to the frame using a hinge with illustration of forces acting on the tablet keyboard system, according to various embodiments of the present technology.

FIG. 7A illustrates a perspective view of a tablet keyboard system including a backplate including a middle protruding member for supporting the tablet computer by contact with a protective case middle housing member, according to various embodiments of the present technology.

FIG. 7B illustrates a side view of a tablet keyboard system including a protective case including a protective case middle housing member and a backplate including a middle protruding member for supporting the tablet computer by contact with the protective case middle housing member, according to various embodiments of the present technology.

FIG. 7C illustrates another magnified view of a tablet keyboard system including a protective case including a protective case middle housing member and a backplate including a middle protruding member for supporting the tablet computer by contact with the protective case middle housing member, according to various embodiments of the present technology.

FIG. 8 illustrates a tablet keyboard system including a protective case including a protective case middle housing member and a backplate including a middle protruding member for supporting the tablet computer by contact with the protective case middle housing member and pivotally connected to the frame using a hinge, according to various embodiments of the present technology.

FIG. 9A illustrates a tablet keyboard system including a protective case including a protective case middle housing member and a backplate including a middle protruding member for supporting the tablet computer by contact with the protective case middle housing member and the backplate pivotally connected to the frame using a hinge with illustration of forces acting on the tablet keyboard system, according to various embodiments of the present technology.

FIG. 9B illustrates a magnified view a tablet keyboard system including a protective case including a protective case middle housing member and a backplate including a middle protruding member for supporting the tablet computer by contact with the protective case middle housing member and the backplate pivotally connected to the frame using a hinge with illustration of forces acting on the tablet keyboard system, according to various embodiments of the present technology.

FIG. 10A illustrates a perspective view of tablet keyboard system including an inverse object system with an inverse object tab protruding beyond an external boundary of the tablet computer for contact with a thumb of the user and an inverse object recession recessed with an internal boundary of the tablet computer, according to various embodiments of the present technology.

FIG. 10B illustrates a magnified front view of a tablet keyboard system including an inverse object system with an inverse object tab protruding beyond an external boundary of the tablet computer for contact with a thumb of the user and an inverse object recession recessed with an internal boundary of the tablet computer, according to various embodiments of the present technology.

FIG. 10C illustrates a magnified back view of a tablet keyboard system including an inverse object system with an inverse object tab protruding beyond an external boundary of the tablet computer for contact with a thumb of the user and an inverse object recession recessed with an internal boundary of the tablet computer, according to various embodiments of the present technology.

FIG. 11A illustrates a front view of a tablet keyboard system including an inverse object system with an inverse object tab protruding beyond an external boundary of the tablet computer for contact with a thumb of the user, according to various embodiments of the present technology.

FIG. 11B illustrates a back view of a tablet keyboard system including an inverse object system with an inverse object tab protruding beyond an external boundary of the tablet computer for contact with a thumb of the user and an inverse object recession recessed with an internal boundary of the tablet computer, according to various embodiments of the present technology.

FIG. 12A illustrates a front view of a tablet keyboard system including a protective case and an inverse object system with an inverse object tab protruding beyond an external boundary of the tablet computer for contact with a thumb of the user, according to various embodiments of the present technology.

FIG. 12B illustrates a back view of a tablet keyboard system including a protective case and an inverse object system with an inverse object tab protruding beyond an external boundary of the tablet computer for contact with a thumb of the user, according to various embodiments of the present technology.

### DETAILED DESCRIPTION

In the following description, for purposes of explanation, numerous specific details are set forth in order to provide a thorough understanding of the disclosure. It will be apparent, however, to one skilled in the art, that the disclosure may be practiced without these specific details. In other instances, structures and devices may be shown in block diagram form only in order to avoid obscuring the disclosure. It should be understood that the disclosed embodiments are merely exemplary of the invention, which may be embodied in multiple forms. Those details disclosed herein are not to be interpreted in any form as limiting, but as the basis for the claims.

A problem in the field is creating a laptop experience with a “clamshell” design for a user of a tablet computer. For example, a laptop computer is designed for portability with a “clamshell” design, where the keyboard and computer components are on a first panel, with a hinged second panel containing a flat display screen. The “clamshell” design may require that the first panel with the computer components be directly connected, using the hinge, without any space between the second panel containing the display screen, like a laptop computer.

In various embodiments, a tablet computer, commonly shortened to “tablet”, is a mobile device, typically with a mobile operating system and touchscreen display a single, thin and flat package. Tablets, being computers, do what other personal computers do, but lack some input/output (I/O) abilities such as a trackpad/touchpad, and keyboard. To compensate for their lack of a physical keyboard, many tablets have the functionality to connect with independent physical keyboards by Bluetooth or USB. However, even tablets connected with physical keyboards lack a laptop experience with a “clamshell” design for the user of the tablet computer. In various embodiments the present technology solves the problem in the field and creates a laptop experience with a “clamshell” design for a user of a tablet computer with the first panel with the computer components be directly connected without any space between the second panel containing the display screen.

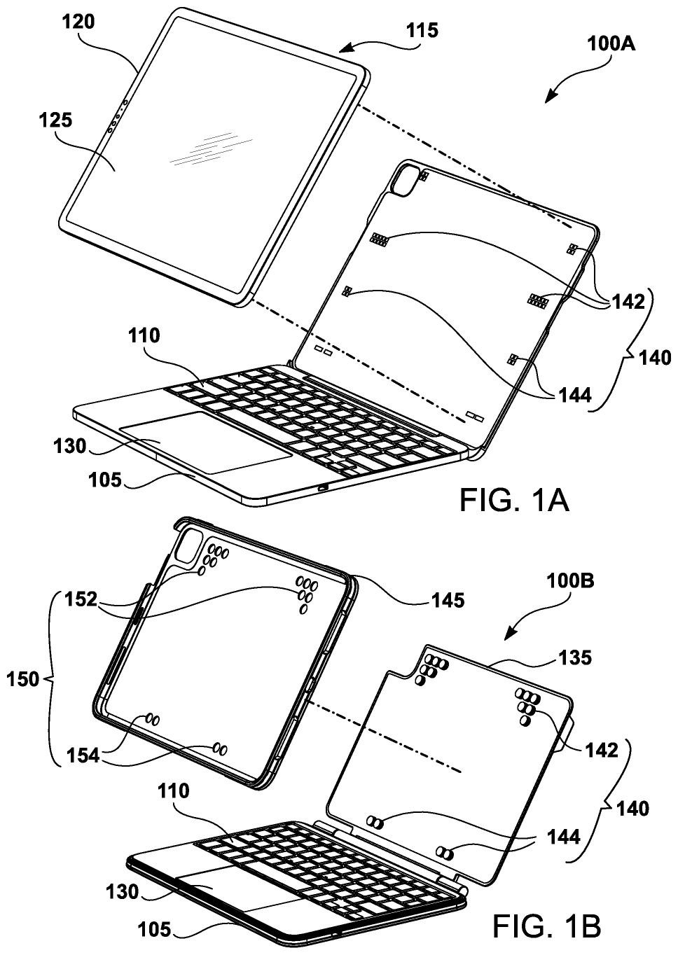

FIG. 1A illustrates a tablet keyboard system 100A including a backplate 135, according to various embodiments of the present technology. The tablet keyboard system 100A creates a laptop experience with a clamshell design the user of a tablet computer 115. In various embodiment the tablet keyboard system 100A includes a frame 105, an electronic keyboard 110 housed by the frame 105. The tablet keyboard system 100A further includes a tablet computer 115 commutatively coupled with the electronic keyboard 110. The tablet computer 115 may include a front panel 120 comprising a touchscreen display 125. The tablet keyboard system 100A further includes a multitouch trackpad 130 housed by the frame 105 and commutatively coupled with the electronic keyboard 110 and the tablet computer 115. The tablet keyboard system 100A further includes a backplate 135 supporting the tablet computer 115 and pivotally connected to the frame 105, the backplate 135 including backplate magnets 140 for mating with the tablet computer 115 by contact with the tablet computer 115, the backplate magnets 140 exerting a backplate magnetic retention force (not shown) on the tablet computer 115, the backplate magnetic retention force preventing release of the tablet computer 115 from the backplate 135.

In some embodiments, the backplate magnets 140 for mating with the tablet computer 115 by contact with the tablet computer 115 comprise a backplate upper magnet array 142, the backplate upper magnet array 142 exerting an upper backplate magnetic retention force on the tablet computer 115, the upper backplate magnetic retention force preventing release of the tablet computer 115 from the backplate 135. In some embodiments, the backplate magnets 140 include a backplate lower magnet array 144, the backplate lower magnet array 144 exerting a lower backplate magnetic retention force on the tablet computer 115, the lower backplate magnetic retention force preventing release of the tablet computer 115 from the backplate 135.

In various embodiments the backplate magnets 140 may mate with the tablet computer 115 by contact with the tablet computer 115 or with protective case magnets 150 (protective case upper magnet array 152 and protective case lower magnet array 154) of a protective case 145 as shown in FIG. 1B.

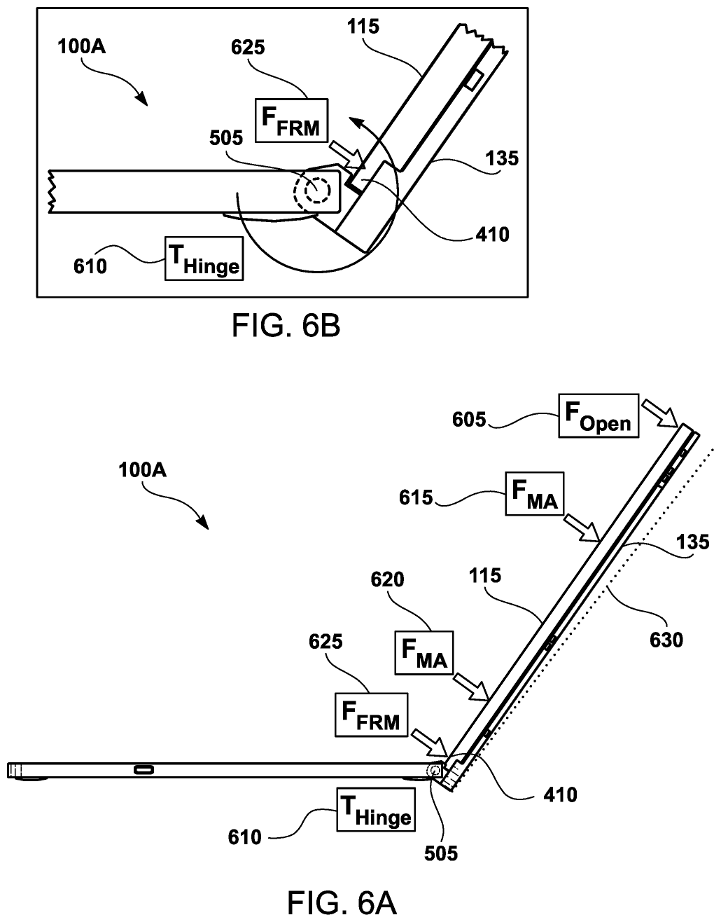

FIG. 1B illustrates tablet keyboard system 100B including the backplate 135 and the protective case 145, according to various embodiments of the present technology. The tablet keyboard system 100B creates a laptop experience with a clamshell design for the user of the tablet computer 115. In various embodiment the tablet keyboard system 100B includes the frame 105, the electronic keyboard 110 housed by the frame 105. The tablet keyboard system 100B further includes the tablet computer 115 commutatively coupled with the electronic keyboard 110. The tablet keyboard system 100B further includes the backplate 135 supporting the tablet computer 115 and the protective case 145 that is pivotally connected to the frame 105, the backplate 135 including backplate magnets 140 for mating with the protective case 145. The protective case 145 may be integrated with the backplate 135 and the protective case 145 may include protective case magnets 150. In some instances, the backplate 135 supporting the tablet computer 115 is pivotally connected to the frame 105, the backplate including backplate magnets 140 for mating with the protective case magnets 150, the backplate magnets 140 exerting a backplate magnetic retention force (shown in FIG. 6) on the protective case 145, the backplate magnetic retention force (shown in FIG. 6) preventing release of the protective case 145 from the backplate 135.

In some embodiments the protective case magnets 150 include protective case upper magnet array 152, the protective case upper magnet array 152 exerting an upper protective case magnetic retention force on the protective case 145, the upper protective case magnetic retention force preventing release of the protective case 145 from the backplate 135. In some instances the protective case magnets 150 include a protective case lower magnet array 154, the protective case lower magnet array 154 exerting a lower protective case magnetic retention force on the protective case 145, the lower protective case magnetic retention force preventing release of the protective case 145 from the backplate 135.

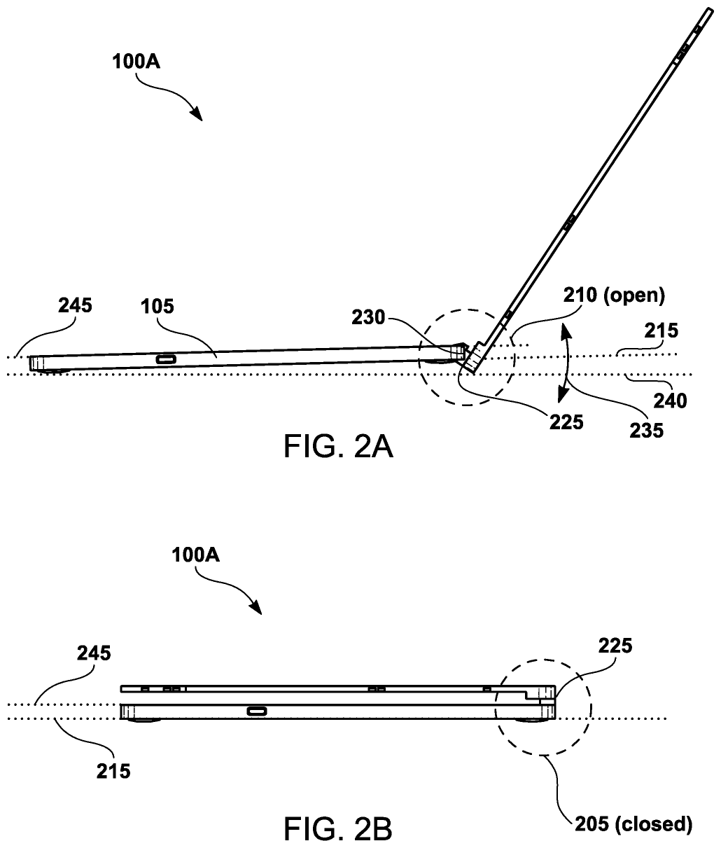

In various embodiments the tablet keyboard system 100A may be positioned by the user between a closed position 205 to the open position 210 optimizing an ergonomic typing angle for a user of the tablet keyboard system 100A as described in FIG. 2A and FIG. 2B.

FIG. 2A illustrates the tablet keyboard system 100A in an open position 210 optimizing an ergonomic typing angle for a user of the tablet keyboard system 100A, according to various embodiments of the present technology. FIG. 2B illustrates a keyboard system in a closed position 205, according to various embodiments of the present technology.

In some embodiments, the frame 105 includes a frame front edge 230, a top frame boundary 245 and a bottom frame boundary 215. For example, the backplate 135 may be supporting the tablet computer 115 and pivotally connected to the frame 105. The backplate 135 including a backplate bottom edge 225, the backplate bottom edge 225 being flush with the bottom frame boundary 215 when the tablet keyboard system 100A is in the closed position 205, and the backplate bottom edge 225 being below the bottom frame boundary 215 when the tablet keyboard system 100A is in the open position 210 allowing the tablet keyboard system 100A to pivot the frame front edge 230 in an upwards position creating an angle 235 between the bottom frame boundary 215 and a resting surface 240 of the bottom frame boundary 215, the angle 235 optimizing an ergonomic typing position for a user.

In various embodiments the user may adjust and personalize the position of the tablet keyboard system 100A in the open position 210 to optimize an ergonomic typing angle for the user of the tablet keyboard system 100A. For example, in some instances, the angle 235 between the bottom frame boundary 215 and the resting surface 240 of the bottom frame boundary 215 is greater than zero degrees and less than three degrees, the angle 235 optimizing the ergonomic typing position for the user of the electronic keyboard of the tablet keyboard system. For example, a user may spend hours using the tablet keyboard system of the present technology and adjusting the angle 235 may be important for preventing injuries and optimizing comfort.

In various embodiments, the angle 235 between the bottom frame boundary 215 and the resting surface 240 of the bottom frame boundary 215 is one degree, the angle 235 optimizing the ergonomic typing position for the user of the electronic keyboard of the tablet keyboard system.

In some embodiments, the angle 235 between the bottom frame boundary 215 and the resting surface 240 of the bottom frame boundary 215 is two degrees, the angle 235 optimizing the ergonomic typing position for the user of the electronic keyboard of the tablet keyboard system.

In various embodiments, wherein the angle 235 between the bottom frame boundary 215 and the resting surface 240 of the bottom frame boundary 215 is three degrees, the angle 235 optimizing the ergonomic typing position for the user of the electronic keyboard of the tablet keyboard system.

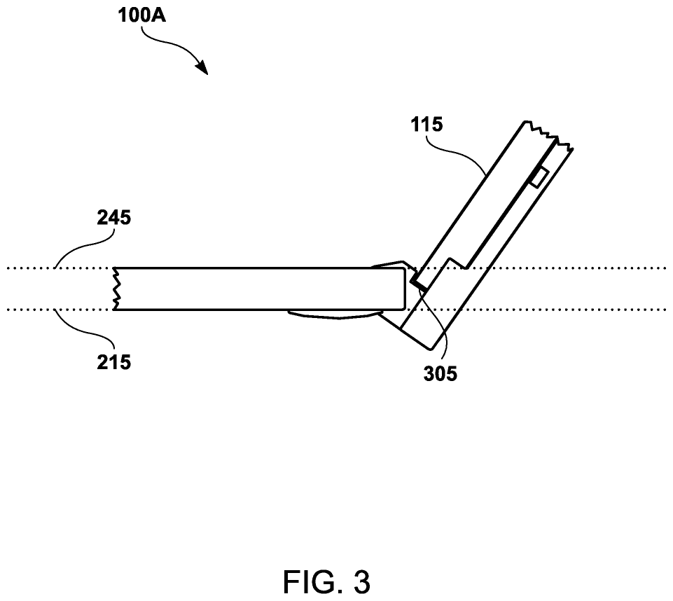

FIG. 3 illustrates a magnified view of the tablet keyboard system 100A in an open position 210 including the top frame boundary 245 and the bottom frame boundary 215, according to various embodiments of the present technology. In some instances, a tablet bottom edge 305 of the tablet computer 115 is below the top frame boundary 245 creating the angle 235 between the bottom frame boundary 215 and the resting surface 240 of the bottom frame boundary 215, the angle 235 further optimizing the ergonomic typing position for the user.

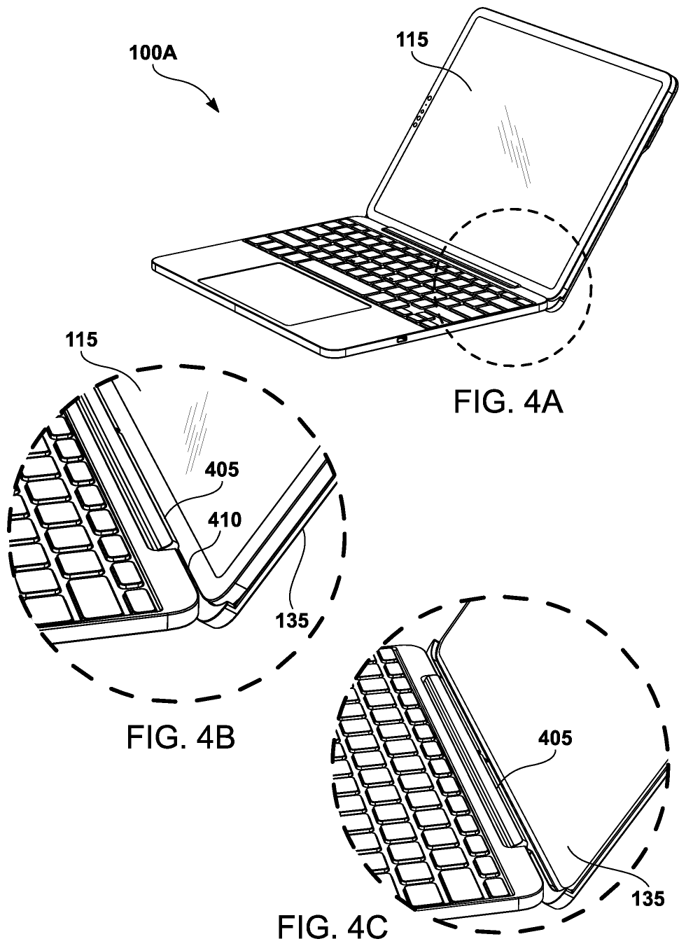

FIG. 4A illustrates a perspective view of tablet keyboard system including the backplate 135 comprising a front receiving member 405 for supporting the tablet computer 115 by contact with the tablet computer front edge 410, according to various embodiments of the present technology.

FIG. 4B illustrates a magnified view of a tablet keyboard system including a backplate 135 comprising a front receiving member 405 for supporting the tablet computer 115 by contact with the tablet computer front edge 410, according to various embodiments of the present technology.

FIG. 4C illustrates another magnified view of a tablet keyboard system including a backplate 135 comprising a front receiving member for supporting the tablet computer 115 by contact with the tablet computer front edge 410, according to various embodiments of the present technology.

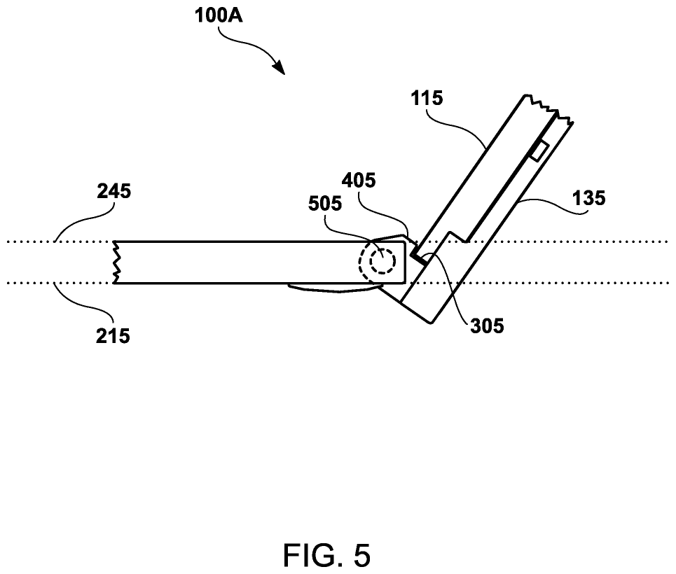

FIG. 5 illustrates another magnified view of the tablet keyboard system 100A including the backplate 135 comprising the front receiving member 405 for supporting the tablet computer 115 by contact with the tablet computer front edge 410 and with the backplate 135 supporting the tablet computer 115 and pivotally connected to the frame 105 using a hinge 505, according to various embodiments of the present technology. In some instances, the tablet computer is pivotally connected to the frame using the hinge 505, the hinge 505 being internal to the frame 105.

In various embodiments, the tablet keyboard system 100A in an open position 210 including the top frame boundary 245 and the bottom frame boundary 215, according to various embodiments of the present technology. In some instances, the tablet bottom edge 305 of the tablet computer 115 is below the top frame boundary 245 creating the angle 235 between the bottom frame boundary 215 and the resting surface 240 of the bottom frame boundary 215, the angle 235 further optimizing the ergonomic typing position for the user. The tablet bottom edge 305 of the tablet computer 115 is below the top frame boundary 245 creating a laptop experience with a clamshell design for user of the tablet keyboard system 100A.

FIG. 6A illustrates another view of a tablet keyboard system 100A including a backplate comprising a front receiving member 405 for supporting the tablet computer 115 by contact with the tablet computer front edge 410 and the backplate 135 pivotally connected to the frame 105 using a hinge 505 with illustration of forces acting on the tablet keyboard system 100A, according to various embodiments of the present technology.

In various embodiments, the forces acting on the tablet keyboard system 100A include F_{Open} 605 being force to open the tablet keyboard system 100A from the user pushing on a top edge of tablet computer 115, T_{Hinge} 610 being resistive torque of an axle, F_{MAU} 615 being force of Upper Magnet Array (the upper backplate magnetic retention force), F_{MAL} 620 being a Force of Lower Magnet Array (the lower backplate magnetic retention force), F_{FRM} 625 being a Force of the front receiving member 405 (the front receiving member retention force). When F_{Open} 605 being the force to open the tablet keyboard system 100A from the user pushing on a top edge of tablet computer 115, the resultant momentum may cause the backplate 135 (the backplate 135 may be made of plastic or other flexible or bendable material) to have bending 630. The bending 630 of the backplate 135 is resisted by the backplate magnets 140 for mating with the tablet computer 115. For example, F_{MAU} 615 being the force of upper magnet array (the upper backplate magnetic retention force) and F_{MAL} 620 being the force of lower magnet array (the lower backplate magnetic retention force). If the F_{Open} 605 becomes too great, the backplate magnets 140 (e.g., the F_{MAU} 615 being the force of upper magnet array (the upper backplate magnetic retention force) and F_{MAL} 620) alone may not retain the tablet computer 115 to the backplate 135. Without the added retention force of the F_{FRM} 625 being the force of front receiving member 405 (the front receiving member retention force), the tablet computer 115 may release from the backplate 135

In some embodiments as the backplate magnets 140 for mating with the tablet computer 115 by contact with the tablet computer 115 includes the backplate upper magnet array 142, the backplate upper magnet array 142 exerting an upper backplate magnetic retention force (F_{MAU} 615 being force of the upper magnet array) on the tablet computer 115, the upper backplate magnetic retention force preventing release of the tablet computer 115 from the backplate 135. In some embodiments, the backplate magnets 140 include the backplate lower magnet array 144, the backplate lower magnet array 144 exerting a lower backplate magnetic retention force (F_{MAL} 620 force of lower magnet array) on the tablet computer 115, the lower backplate magnetic retention force preventing release of the tablet computer 115 from the backplate 135.

In some embodiments, the backplate magnets 140 for mating with the tablet computer 115 by contact with the tablet computer 115, the backplate magnets 140 exerting a backplate magnetic retention force on the tablet computer (F_{MAU} 615 being force of the upper magnet array and F_{MAL} 620 force of lower magnet array), the backplate magnetic retention force preventing release of the tablet computer from the backplate.

In various embodiments, the front receiving member 405 for supporting the tablet computer 115 by contact with the tablet computer front edge 410 causes the front receiving member 405 to exert a front receiving member retention force (F_{FRM} 625 being the force of front receiving member 405) on the tablet computer front edge 410, the front receiving member retention force (F_{FRM} 625 being the force of front receiving member 405) on the tablet computer front edge 410 preventing release of the tablet computer 115 from the backplate 135.

FIG. 6B illustrates a magnified view of a tablet keyboard system 100A including a backplate 135 comprising a front receiving member 405 for supporting the tablet computer 115 by contact with the tablet computer front edge 410 and the backplate 135 pivotally connected to the frame 105 using a hinge 505 with illustration of forces acting on the tablet keyboard system 100A as described above, according to various embodiments of the present technology.

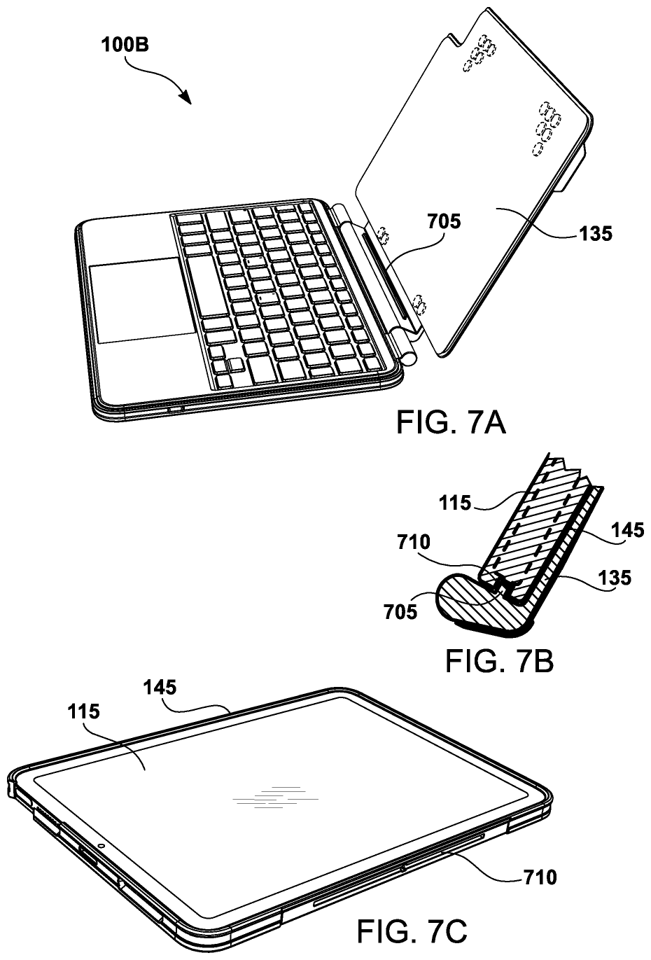

FIG. 7A illustrates a perspective view of a tablet keyboard system 100B including a backplate 135 including a middle protruding member 705 for supporting the tablet computer 115 by contact with a protective case middle housing member 710, according to various embodiments of the present technology. The protective case 145 may be integrated with the backplate 135, the protective case 145 may include a protective case middle housing member 710 that mates with the middle protruding member 705 for supporting the tablet computer 115.

FIG. 7B illustrates a side view of a tablet keyboard system 100B including a protective case 145 including a protective case middle housing member 710 and a backplate 135 including the middle protruding member 705 for supporting the tablet computer 115 by contact with the protective case middle housing member 710, according to various embodiments of the present technology.

FIG. 7C illustrates another magnified view of a tablet keyboard system 100B including a protective case 145 including a protective case middle housing member 710 and a backplate 135 including a middle protruding member 705 for supporting the tablet computer 115 by contact with the protective case middle housing member 710, according to various embodiments of the present technology.

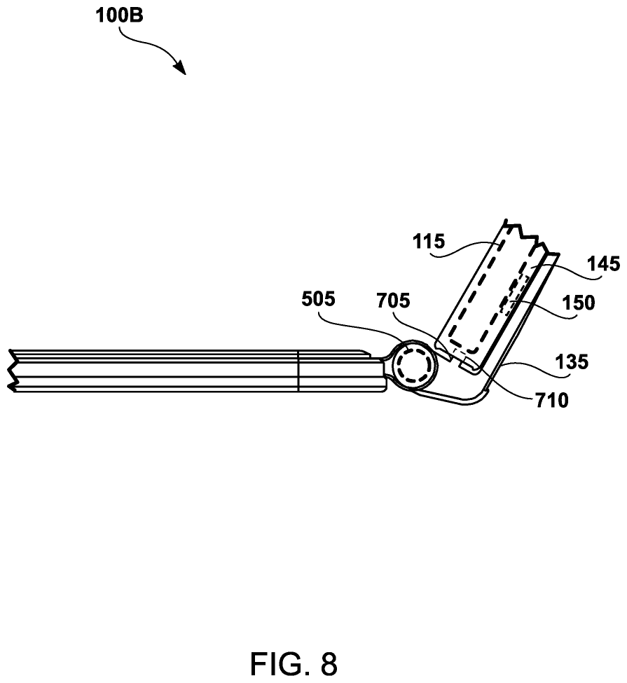

FIG. 8 illustrates a tablet keyboard system 100B including a protective case 145 including a protective case middle housing member 710 and a backplate 135 including a middle protruding member 705 for supporting the tablet computer 115 by contact with the protective case middle housing member 710 and pivotally connected to the frame 105 using a hinge 505, according to various embodiments of the present technology.

In various embodiments, the middle protruding member 705 for supporting the tablet computer 115 by contact with the protective case middle housing member 710 causes the middle protruding member 705 to exert a middle protruding member retention force on the protective case middle housing member, the middle protruding member retention force preventing release of the protective case from the backplate.

According to various embodiments, FIG. 8 illustrates the protective case 145 being integrated with the backplate 135, the protective case 145 including a protective case middle housing member 710 that mates with the middle protruding member 705 for supporting the tablet computer 115.

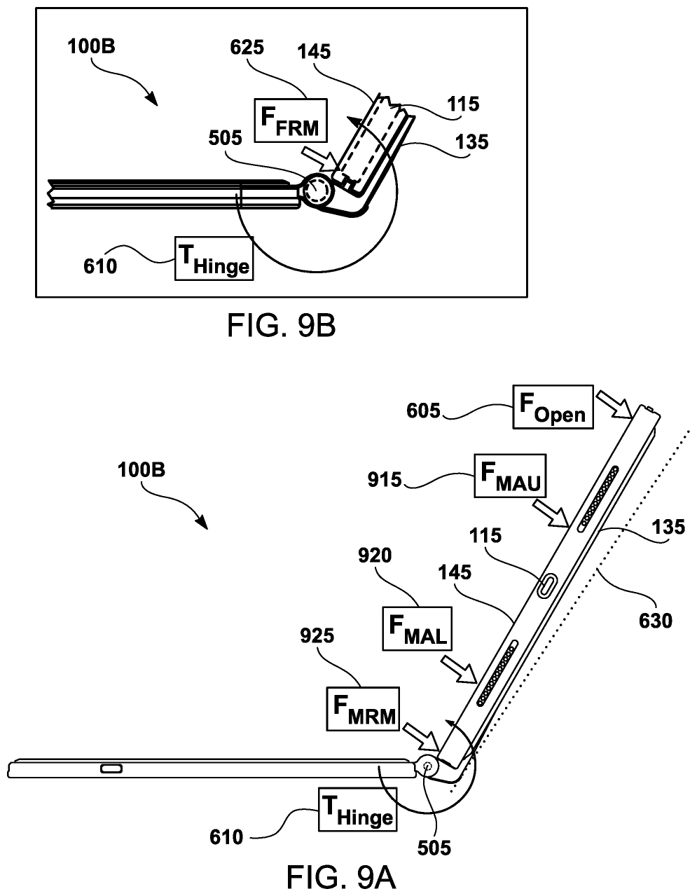

Turning to FIG. 9A and FIG. 9B. FIG. 9A illustrates a tablet keyboard system 100B including a protective case 145 including a protective case middle housing member 710 and a backplate 135 including a middle protruding member 705 for supporting the tablet computer 115 by contact with the protective case middle housing member 710 and the backplate 135 pivotally connected to the frame 105 using a hinge 505 with illustration of forces acting on the tablet keyboard system 100B, according to various embodiments of the present technology.

In various embodiments, the forces acting on the tablet keyboard system 100B include F_{Open} 605 being force to open the tablet keyboard system 100B from the user pushing on a top edge of tablet computer 115, T_{Hinge} 610 being resistive torque of an axle, F_{MAU} 915 being force of upper protective case magnet array (the upper protective case magnetic retention force), F_{MAL} 920 being a force of lower protective case magnet array (the lower protective case magnetic retention force), F_{FRM} 925 being a force of the protective case middle housing member 710 mating with the middle protruding member 705 for supporting the tablet computer 115. When F_{Open} 605 being the force to open the tablet keyboard system 100B from the user pushing on a top edge of tablet computer 115, the resultant moment may cause the backplate 135 (the backplate 135 may be made of plastic or other flexible or bendable material) to have bending 630. In various embodiments, the backplate 135 supporting the tablet computer 115 is made of flexible material. For example, the flexible material may be plastic. The bending 630 of the backplate 135 is resisted by the protective case magnets 150 for mating with the tablet computer 115. For example, F_{MAU} 915 being force of upper protective case magnet array (the upper protective case magnetic retention force), and F_{MAL} 920 being a force of lower protective case magnet array (the lower protective case magnetic retention force. If the F_{Open} 605 becomes too great, the protective case magnets 150 (e.g., F_{MAU} 915 being force of upper protective case magnet array (the upper protective case magnetic retention force) and F_{MAL} 920 being a force of lower protective case magnet array (the lower protective case magnetic retention force) alone may not retain the tablet computer 115 to the backplate 135. Without the added retention force of the F_{FRM} 925 being a force of the protective case middle housing member 710 mating with the middle protruding member 705 for supporting the tablet computer 115, the tablet computer 115 may release from the backplate 135.

The protective case 145 may be integrated with the backplate 135 and the protective case 145 may include protective case magnets 150. In some instances, the backplate 135 supporting the tablet computer 115 is pivotally connected to the frame 105, the backplate including backplate magnets 140 for mating with the protective case magnets 150, the backplate magnets 140 exerting a backplate magnetic retention force on the protective case 145, the backplate magnetic retention force preventing release of the protective case 145 from the backplate 135.

In some embodiments the protective case magnets 150 include protective case upper magnet array 152, the protective case upper magnet array 152 exerting an upper protective case magnetic retention force on the protective case 145, the upper protective case magnetic retention force preventing release of the protective case 145 from the backplate 135. In some instances the protective case magnets 150 include a protective case lower magnet array 154, the protective case lower magnet array 154 exerting a lower protective case magnetic retention force on the protective case 145, the lower protective case magnetic retention force preventing release of the protective case 145 from the backplate 135.

FIG. 9B illustrates a magnified view a tablet keyboard system 100B including a protective case 145 including a protective case middle housing member 710 and a backplate 135 including a middle protruding member 705 for supporting the tablet computer 115 by contact with the protective case middle housing member 710 and the backplate 135 pivotally connected to the frame 105 using a hinge 505 with illustration of forces acting on the tablet keyboard system 100B, according to various embodiments of the present technology.

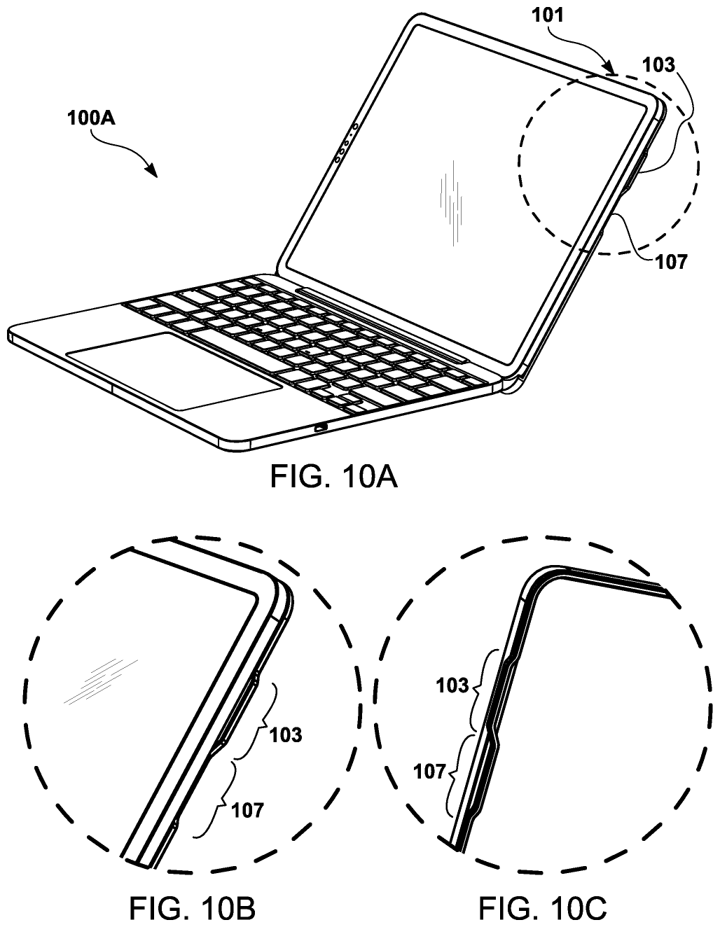

FIG. 10A illustrates a perspective view of tablet keyboard system 100A including an inverse object system 101 with an inverse object tab 103 protruding beyond an external boundary of the tablet computer 115 for contact with a thumb of the user and an inverse object recession 107 recessed with an internal boundary of the tablet computer 115, according to various embodiments of the present technology.

FIG. 10B illustrates a magnified front view of a tablet keyboard system 100A including an inverse object system 101 with an inverse object tab 103 protruding beyond an external boundary of the tablet computer 115 for contact with a thumb of the user and an inverse object recession recessed with an internal boundary of the tablet computer 115, according to various embodiments of the present technology.

FIG. 10C illustrates a magnified back view of a tablet keyboard system 100A including an inverse object system 101 with an inverse object tab 103 protruding beyond an external boundary of the tablet computer 115 for contact with a thumb of the user and an inverse object recession recessed with an internal boundary of the tablet computer 115, according to various embodiments of the present technology.

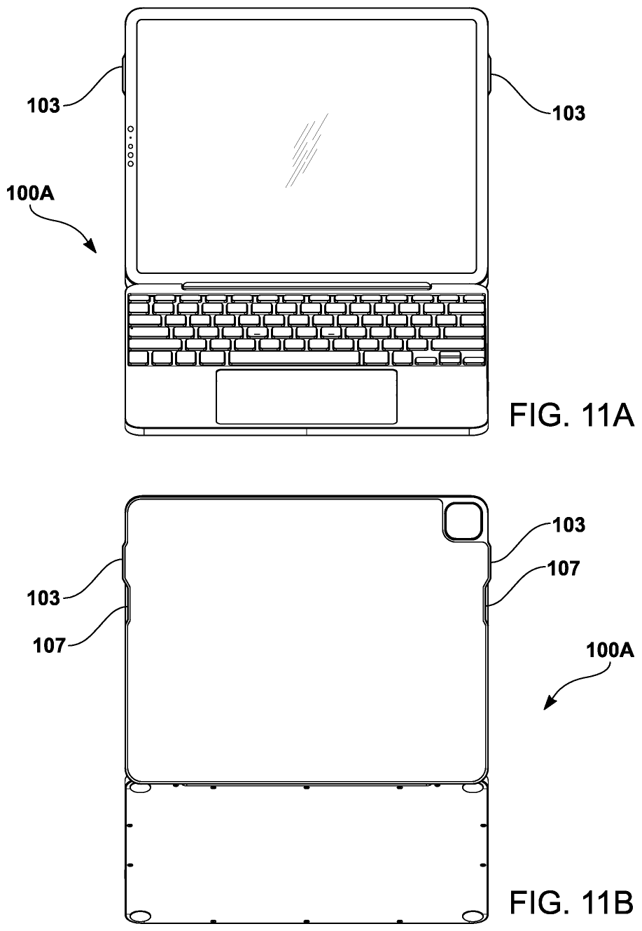

FIG. 11A illustrates a front view of a tablet keyboard system 100A including an inverse object system 101 with an inverse object tab 103 protruding beyond an external boundary of the tablet computer 115 for contact with a thumb of the user, according to various embodiments of the present technology.

FIG. 11B illustrates a back view of a tablet keyboard system 100A including an inverse object system 101 with an inverse object tab 103 protruding beyond an external boundary of the tablet computer 115 for contact with a thumb of the user and an inverse object recession recessed with an internal boundary of the tablet computer 115, according to various embodiments of the present technology.

In various embodiments, simultaneous contact with the inverse object tab 103 by the thumb of the user and contact with the inverse object recession 107 by the index finger of the user causes an inverse object system release force on the tablet computer 115, the inverse object system release force causing release of the tablet computer 115 from the backplate 135 when the inverse object system release force is greater than a combination of the front receiving member retention force (F_{FRM} 625 being the force of front receiving member 405) and the backplate magnetic retention force (F_{MAU} 615 being force of the upper magnet array and F_{MAL} 620 force of lower magnet array.

In some embodiments, a distance between a center of the inverse object tab 103 protruding beyond the external boundary of the tablet computer 115 for contact with a thumb of the user and a center of the inverse object recession 107 recessed with the internal boundary of the tablet computer 115 for contact with an index finger of the user is an optimal release distance, the optimal release distance being a distance measured of a human hand from a tip of a thumb to a tip of the index finger of the human hand fully stretched, the distance measured being between two and four inches.

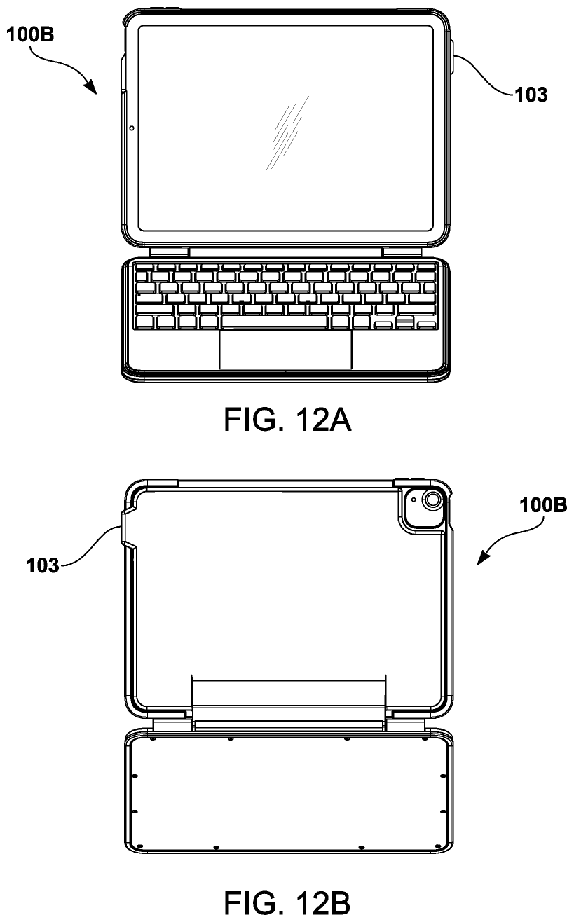

FIG. 12A illustrates a front view of a tablet keyboard system 100B including a protective case and an inverse object system 101 with an inverse object tab 103 protruding beyond an external boundary of the tablet computer 115 for contact with a thumb of the user, according to various embodiments of the present technology.

FIG. 12B illustrates a back view of a tablet keyboard system 100B including a protective case and an inverse object system 101 with an inverse object tab 103 protruding beyond an external boundary of the tablet computer 115 for contact with a thumb of the user, according to various embodiments of the present technology.

Thus, the technology for a tablet keyboard system is disclosed. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A tablet keyboard system for a creating a laptop experience with a clamshell design, the tablet keyboard system comprising:
a frame comprising:
a frame front edge;
a top frame boundary; and
a bottom frame boundary;
an electronic keyboard housed by the frame;
a tablet computer commutatively coupled with the electronic keyboard, the tablet computer comprising:
a front panel comprising:
a touchscreen display; and
a tablet computer front edge; and
a back panel;
a multitouch trackpad housed by the frame and commutatively coupled with the electronic keyboard and the tablet computer;
a backplate supporting the tablet computer and pivotally connected to the frame, the backplate comprising:
backplate magnets for mating with the tablet computer by contact with the tablet computer, the backplate magnets exerting a backplate magnetic retention force on the tablet computer, the backplate magnetic retention force preventing release of the tablet computer from the backplate;
a front receiving member for supporting the tablet computer by contact with the tablet computer front edge, the front receiving member exerting a front receiving member retention force on the tablet computer front edge, the front receiving member retention force on the tablet computer front edge preventing release of the tablet computer from the backplate; and
a backplate bottom edge, the backplate bottom edge being flush with the bottom frame boundary when the tablet keyboard system is in a closed position, and the backplate bottom edge being below the bottom frame boundary when the tablet keyboard system is in an open position allowing the tablet keyboard system to pivot the frame front edge in an upwards position creating an angle between the bottom frame boundary and a resting surface of the bottom frame boundary, the angle optimizing an ergonomic typing position for a user; and
an inverse object system comprising:
an inverse object tab protruding beyond an external boundary of the tablet computer for contact with a thumb of the user; and
an inverse object recession recessed with an internal boundary of the tablet computer for contact with an index finger of the user.

2. The tablet keyboard system of claim 1,
wherein the angle between the bottom frame boundary and the resting surface of the bottom frame boundary is greater than zero degrees and less than three degrees, the angle optimizing the ergonomic typing position for the user of the electronic keyboard of the tablet keyboard system.

3. The tablet keyboard system of claim 1,
wherein the angle between the bottom frame boundary and the resting surface of the bottom frame boundary is one degree, the angle optimizing the ergonomic typing position for the user of the electronic keyboard of the tablet keyboard system.

4. The tablet keyboard system of claim 1,
wherein the angle between the bottom frame boundary and the resting surface of the bottom frame boundary is two degrees, the angle optimizing the ergonomic typing position for the user of the electronic keyboard of the tablet keyboard system.

5. The tablet keyboard system of claim 1,
wherein the angle between the bottom frame boundary and the resting surface of the bottom frame boundary is three degrees, the angle optimizing the ergonomic typing position for the user of the electronic keyboard of the tablet keyboard system.

6. The tablet keyboard system of claim 1, wherein simultaneous contact with the inverse object tab by the thumb of the user and contact with the inverse object recession by the index finger of the user causes an inverse object system release force on the tablet computer, the inverse object system release force causing release of the tablet computer from the backplate when the inverse object system release force is greater than a combination of the front receiving member retention force and the backplate magnetic retention force.

7. The tablet keyboard system of claim 6, wherein simultaneous contact with the inverse object tab by the thumb of the user and contact with the inverse object recession by the index finger of the user causes an inverse object system release force on the tablet computer, the inverse object system release force causing release of the tablet computer from the backplate when the inverse object system release force is greater than a combination of the front receiving member retention force and the backplate magnetic retention force.

8. The tablet keyboard system of claim 6, wherein a distance between a center of the inverse object tab protruding beyond the external boundary of the tablet computer for contact with a thumb of the user and a center of the inverse object recession recessed with the internal boundary of the tablet computer for contact with an index finger of the user is an optimal release distance, the optimal release distance being a distance measured of a human hand from a tip of a thumb to a tip of the index finger of the human hand fully stretched, the distance measured being between two and four inches.

9. The tablet keyboard system of claim 1, wherein the backplate magnets for mating with the tablet computer by contact with the tablet computer comprise:
a backplate upper magnet array, the backplate upper magnet array exerting an upper backplate magnetic retention force on the tablet computer, the upper backplate magnetic retention force preventing release of the tablet computer from the backplate; and
a backplate lower magnet array, the backplate lower magnet array exerting a lower backplate magnetic retention force on the tablet computer, the lower backplate magnetic retention force preventing release of the tablet computer from the backplate.

10. A tablet keyboard system for a creating a laptop experience with a clamshell design, the tablet keyboard system being in an open position comprising:
a frame comprising:
a frame front edge;
a top frame boundary; and
a bottom frame boundary;
an electronic keyboard housed by the frame;
a tablet computer commutatively coupled with the electronic keyboard, the tablet computer comprising:
a front panel comprising:
a touchscreen display; and
a tablet computer front edge; and
a back panel;
a multitouch trackpad housed by the frame and commutatively coupled with the electronic keyboard and the tablet computer;
a backplate supporting the tablet computer and pivotally connected to the frame, the backplate comprising:
backplate magnets for mating with the tablet computer by contact with the tablet computer, the backplate magnets exerting a backplate magnetic retention force on the tablet computer, the backplate magnetic retention force preventing release of the tablet computer from the backplate; and
a backplate bottom edge being below the bottom frame boundary with the tablet keyboard system in the open position allowing the tablet keyboard system to pivot the frame front edge in an upwards position creating an angle between the bottom frame boundary and a resting surface of the bottom frame boundary, the angle optimizing an ergonomic typing position for a user; and
an inverse object system comprising:
an inverse object tab protruding beyond an external boundary of the tablet computer for contact with a thumb of the user; and
an inverse object recession recessed with an internal boundary of the tablet computer for contact with an index finger of the user.

11. A tablet keyboard system for a creating a laptop experience with a clamshell design, the tablet keyboard system being in an open position comprising:
a frame comprising:
a frame front edge;
a top frame boundary; and
a bottom frame boundary;
an electronic keyboard housed by the frame;
a tablet computer commutatively coupled with the electronic keyboard, the tablet computer comprising:
a front panel comprising:
a touchscreen display; and
a tablet computer front edge; and
a back panel;
a multitouch trackpad housed by the frame and commutatively coupled with the electronic keyboard and the tablet computer;
a backplate supporting the tablet computer and pivotally connected to the frame, the backplate comprising:
backplate magnets for mating with the tablet computer by contact with the tablet computer, the backplate magnets exerting a backplate magnetic retention force on the tablet computer, the backplate magnetic retention force preventing release of the tablet computer from the backplate;
a front receiving member for supporting the tablet computer by contact with the tablet computer front edge, the front receiving member exerting a front receiving member retention force on the tablet computer front edge, the front receiving member retention force on the tablet computer front edge preventing release of the tablet computer from the backplate; and
a backplate bottom edge being below the bottom frame boundary with the tablet keyboard system in the open position allowing the tablet keyboard system to pivot the frame front edge in an upwards position creating an angle between the bottom frame boundary and a resting surface of the bottom frame boundary, the angle optimizing an ergonomic typing position for a user; and
an inverse object system comprising:
an inverse object tab protruding beyond an external boundary of the tablet computer for contact with a thumb of the user; and
an inverse object recession recessed with an internal boundary of the tablet computer for contact with an index finger of the user.

12. The tablet keyboard system of claim 11, wherein a bottom edge of the tablet computer is below the top frame boundary creating the angle between the bottom frame boundary and the resting surface of the bottom frame boundary, the angle further optimizing the ergonomic typing position for the user.

13. The tablet keyboard system of claim 11, wherein the backplate supporting the tablet computer is pivotally connected to the frame using a hinge, the hinge being internal to the frame.

14. The tablet keyboard system of claim 11, wherein the backplate supporting the tablet computer is made of flexible material.

15. The tablet keyboard system of claim 14, wherein, the flexible material is plastic.

16. A tablet keyboard system for a creating a laptop experience with a clamshell design, the tablet keyboard system being in a closed position comprising:
a frame comprising:
a frame front edge;
a top frame boundary; and
a bottom frame boundary;
an electronic keyboard housed by the frame;
a tablet computer commutatively coupled with the electronic keyboard, the tablet computer comprising:
a front panel comprising:
a touchscreen display; and
a tablet computer front edge; and
a back panel;
a multitouch trackpad housed by the frame and commutatively coupled with the electronic keyboard and the tablet computer;
a backplate supporting the tablet computer and pivotally connected to the frame, the backplate comprising:
backplate magnets for mating with the tablet computer by contact with the tablet computer, the backplate magnets exerting a backplate magnetic retention force on the tablet computer, the backplate magnetic retention force preventing release of the tablet computer from the backplate;
a front receiving member for supporting the tablet computer by contact with the tablet computer front edge, the front receiving member exerting a front receiving member retention force on the tablet computer front edge, the front receiving member retention force on the tablet computer front edge preventing release of the tablet computer from the backplate; and
a backplate bottom edge, the backplate bottom edge being flush with the bottom frame boundary with the tablet keyboard system in the closed position, and
an inverse object system comprising:
an inverse object tab protruding beyond an external boundary of the tablet computer for contact with a thumb of a user; and
an inverse object recession recessed with an internal boundary of the tablet computer for contact with an index finger of the user.

17. A tablet keyboard system for a creating a laptop experience with a clamshell design, the tablet keyboard system comprising:
a frame comprising:
a frame front edge;
a top frame boundary; and
a bottom frame boundary;
an electronic keyboard housed by the frame;
a tablet computer commutatively coupled with the electronic keyboard, the tablet computer comprising:
a front panel comprising:
a touchscreen display; and
a tablet computer front edge; and
a back panel;
a multitouch trackpad housed by the frame and commutatively coupled with the electronic keyboard and the tablet computer;
a protective case integrated with a backplate, the protective case comprising:
protective case magnets;
a protective case middle housing member;
the backplate supporting the tablet computer and pivotally connected to the frame, the backplate comprising:
backplate magnets for mating with the protective case magnets, the backplate magnets exerting a backplate magnetic retention force on the protective case, the backplate magnetic retention force preventing release of the protective case from the backplate;
a middle protruding member for supporting the tablet computer by contact with the protective case middle housing member, the middle protruding member exerting a middle protruding member retention force on the protective case middle housing member, the middle protruding member retention force preventing release of the protective case from the backplate;
a backplate bottom edge, the backplate bottom edge being flush with the bottom frame boundary when the tablet keyboard system is in a closed position, and the backplate bottom edge being below the bottom frame boundary when the tablet keyboard system is in an open position allowing the tablet keyboard system to pivot the frame front edge in an upwards position creating an angle between the bottom frame boundary and a resting surface of the bottom frame boundary, the angle optimizing an ergonomic typing position for a user; and
an inverse object system comprising:
an inverse object tab protruding beyond an external boundary of the tablet computer for contact with a thumb of the user; and
an inverse object recession recessed with an internal boundary of the tablet computer for contact with an index finger of the user; and
a protective case.

18. The tablet keyboard system of claim 17, wherein the protective case magnets comprise:
a protective case upper magnet array, the protective case upper magnet array exerting an upper protective case magnetic retention force on the protective case, the upper protective case magnetic retention force preventing release of the protective case from the backplate; and
a protective case lower magnet array, the protective case lower magnet array exerting a lower protective case magnetic retention force on the protective case, the lower protective case magnetic retention force preventing release of the protective case from the backplate.

19. The tablet keyboard system of claim 17, wherein the middle protruding member is embodied in the protective case middle housing member.

20. The tablet keyboard system of claim 17, wherein a tablet bottom edge of the tablet computer is below the bottom frame boundary.
